(19) United States
(12) Patent Application Publication
(10) Pub. No.: US 2017/0134584 A1
(43) Pub. Date: May 11, 2017

(54) SYSTEM AND METHOD FOR DIALLING A TELEPHONE NUMBER USING A VOIP PLATFORM AND A MOBILE RADIO

(71) Applicant: ANDREAS WESTERMAIER, FREISING (DE)

(72) Inventor: ANDREAS WESTERMAIER, FREISING (DE)

(21) Appl. No.: 15/303,431

(22) PCT Filed: Apr. 9, 2014
(86) PCT No.: PCT/DE2014/000183

§ 371 Date: Dec. 30, 2016

(51) Int. Cl. H04M 7/00; H04M 1/253

(52) U.S. Cl. CPC H04M 7/0069; H04M 1/2535

(57) ABSTRACT

The present invention introduces a system (1) for IP telephony that is distinguished by the special interaction between a party (2) calling from a terminal connected to a router and an arbitrary called party (3, 4), which allows the costs for calls from the terminal to mobile radio networks and other networks to be substantially lowered, or even eliminates them completely, or settles the current call costs from the mobile radio network (9). To this end, a mobile radio (6) has a piece of software (7) installed on it that, together with an appropriately configured router (5), allows the IP telephony from terminals (2) connected to this router using a mobile radio network.

The present invention relates to a system and a method for selecting an arbitrary call number of a router and a VoIP platform, especially via the mobile network connection of a selected vendor, as well as the accessibility of a connected to a mobile network terminal via a router and a VoIP platform.

In the prior art a Telephone and Internet connection with at least one respective provider (telecom, 1 & 1, etc.) is typically installed in a household. To use the Telephone and internet, generally the domestic communication system exhibits a router which is connected to the Telephone and Internet connection. In addition, these routers today have also simultaneously the possibilities of a telephone system, in particular for Internet telephony (VoIP, Voice over IP), both internally and externally, as well as for wireless data transmission via WLAN (Wireless Local Area Network).

Telephones, VoIP telephones, fax, answering machine, etc., are no longer directly connected to the telephone line, but to the router, which in turn connects to the telephone network. The customer does not mind which technology is used for the telephone connection, eg. B. Analog (PSTN), ISDN, VoIP (Voice over Internet Protocol), VoLTE (Voice over LTE) or others. The router makes here the connections for the phone devices available, so that the actual call set for incoming and outgoing calls are always performed via the router to the telephone providers. Therefore all calls are sent to the telephone provider through the telephone provider. Modern routers also offer the possibility of multiple vendors to operate in parallel, to each of which a contractual relationship exists.

The customer has the freedom based on the configuration of the router to decide which calls are handled through which provider. For this purpose, in the router, for example, it is set on the code by dialling, which objectives to be handled via which provider. Further setting for vendor selection, for example, depending on the day of the week, date or time of day or in consideration of connection Price Tables (Least Cost Routing) and other, are also configurable depending on the router model. For example, the following configuration could be made: international calls always via provider A (code 00) and calls within Germany (code 0 or built-up areas without area code) via the supplier B.

As another example, the following configuration could be made: On Sunday between 8.00 and 20.00 h selected provider B, otherwise A provider, for outgoing calls. The customer selects the destination number on his phone and the router makes, based on the settings, the decision on which provider and thus at what cost the call should be made.

The so-called IP telephony (Internet Protocol Telephony) plays a special role. In the IP telephony call data to the selected interlocutor or its suppliers be delivered via the Internet or an IP network, which generally under the English name “Voice over Internet Protocol”, short VoIP, has become known. Here are typical for telecommunication information, that Language and control information transfer, for example to establish the connection, via a usable for data transmission network. IP telephony is a technology that makes it possible to realize the telephone service on IP infrastructure so that they can replace conventional telephone technology, including POTS, ISDN, switching centers, network and all components.

Objective here is to reduce costs by a uniformly structured and to be operated network. This gives a clear need for solutions obtained to relate the two telephony systems (eg via VoIP gateways) and the need for specific planning of the system change taking into account the possibilities for expense and performance optimization. It accepts a switching service in the form of a server task and enables telephony even with changing IP addresses of network subscribers or IP phones. This is done so that to sign the VoIP phones to the server and the server to know the current IP address of the phone. Using the IP address of the phone, which was made known to the SIP server, it can take mediation and the IP phone will ring when selecting the number of a subscriber, depending on its IP address when the IP phone has previously registered from there to the mediation server.

Making calls with the IP telephony can be represented for the participants as well as in traditional telephony. As with traditional telephony, the telephone conversation divides it into three basic operations, the connection, the call transfer and termination. Unlike the traditional telephone are in VoIP but no dedicated “lines” are turned on, but the speech is digitized and transported in small data packets over the IP protocol.

The building and degradation of calls (signaling) is under a protocol separate from the voice communication protocol. The negotiation and exchange of parameters for voice transmission are done through separate protocols. Here, the connection has a special role with SIP (Session Initiation Protocol). Basically, SIP is also suitable for application scenarios beyond VoIP and video telephony.

Participants have at SIP a SIP address (similar to an e-mail address) in the Uniform Resource Identifier format (URI format), such as “sip: 12345@example.com”. SIP terminals must register regularly with a SIP registrar server. To establish a connection, the terminal of the caller sends a message to this server, which is the DNS known by the domain name “example.com” or fixed in the terminal. The server forwards the message to the IP-address of the called party known to the server, with which the party has previously been registered on the server.

Direct communication between the two terminals has not yet taken place until now. To establish a connection between the terminals initially the negotiation of connection parameters is performed. As part of this exchange to establish a session with all relevant information about features and capabilities are exchanged between the terminals. The units of caller and called agree thereby for this connection to transmission methods and protocols that are supported by both sides. For the transmission of this data in real time usually the Real-Time Transport Protocol (RTP) is used. To end the conversation, one of the terminals sends a SIP message to the server, which sends it to the other party. Both devices then end the connection. For users who want to make calls over the Internet with other Internet users, many service providers offer SIP addresses. SIP addresses, unlike telephone numbers or MSNs, are not tied to a port, but as e-mail accounts from any Internet connection in the world available.

Various service providers offer the assignment of a landline phone number to a SIP address and take over the routing of calls between different networks. The user is thus reachable with his VoIP phone and its SIP address also from the conventional telephone network.

Such methods and systems are known beyond the art from DE 10 2011 0 53 994 B3. This document discloses a method that a calling party opens the possibility of using a telephone terminal by dialing a landline phone number to make a phone call with a used mobile terminal for the telephone call participant if the mobile phone number of the called party to a VoIP platform in association with the called landline phone number has earlier been registered. A disadvantage of this method, it is felt that to call a mobile phone number, the mobile telephone number must be previously registered to interact via the VoIP platform.

Another method and associated systems have become known from DE 10 2006 050 328 A1. This document relates to a call forwarding for a VoIP telephone call wherein a redirect server is installed on the terminal of a caller. The invention provides that in the case of impossibility of connecting a dialed telephone connection to an IP address, an alternative connection is established. A disadvantage of this system is on the one hand that the alternative connections all must be registered in advance and on the other hand, the technical expenditure is comparatively high to produce a desired connection.

A disadvantage of the entire prior art, it is also felt that (VoIP-) routers provide no simple way to use an existing mobile terminal without any additional equipment and high technical complexity as a provider for external calls with telephone equipment existing and connected to the router. It should also be seen as a disadvantage that an incoming call on a mobile device call cannot be accepted without additional expense to the existing, connected to the router telephone equipment. Although the prior art exist complex solutions, but include independent and expensive equipment, a SIM card from a wireless service provider must be inserted separately into the equipment or which function only in cooperation with a mobile device via the Bluetooth interface.

It is therefore an object of the present invention to provide a system and method which is able to perform at least one phone call to any telephone subscriber of at least one terminal apparatus, connected to a router device, through at least one wireless connection of a mobile telephone.

A further aspect of the present invention is seen to provide a system and method which is capable of receiving incoming calls assigned to at least one calling number at at least a mobile device, to at least one terminal and to lead, which is connected to a router. This object is solved by the characterizing features of the main claims.

The inventive system for selecting a desired telephone conversation partner via the telephone connection of a wireless service provider, at least one router and at least one mobile device on which software is stored on the caller side, is characterized in that the software installed on the mobile device, an additional function, a VoIP server, is created on the mobile device so that when selecting a desired telephone number in the fixed network or a mobile radio network, constructed from a computer connected to the router device, the telephone connection via the cellular connection and the voice data is transmitted over.

The inventive method for selecting a desired telephone conversation partner via the telephone connection of a wireless service provider, with at least one router and at least one mobile device on which software is stored on the caller side, is characterized in that the software installed on the mobile device, an additional function, a VoIP server, created on the mobile device so that when selecting a desired telephone number in the fixed network or a mobile radio network, from a computer connected to the router device, the telephone connection to the selected number via a VoIP platform is established.

This method is realized by using the pre-installed software in the router as an additional provider to the existing offerings such as for example Telecom, 1 & 1, its own mobile device, tablet, etc. with a service plan as a “provider” is produced.

As a result of the performance of today's mobile devices, it is possible to operate a VoIP server (SIP server) on mobile devices, as described by the well-known providers (Telekom, 1 & 1, Sipgate etc.) is usually operated in large data centers. This results in the ability to transform mobile phones with a phone interface to the mobile network in a mobile phone server or a VoIP gateway. Given offers to install the software on a mobile phone the ability to configure the local router to expensive calls in specific networks (for example mobile networks), no longer can be handled via the fixed network provider, but via the mobile device or the associated mobile phone contract and thus also to the given contractual conditions.

Since today an “Allnet” flat rate is widely spread to all mobile networks and landlines with mobile phone contracts, generating software thus no more additional costs for mobile calls covered when using a server in the mobile device in the system according to the invention.

Thus, by the integration of the mobile station in the domestic telecommunications infrastructure as a home or office with the traditional landline phones or terminals on the phone and the tariff benefits of a mobile phone contract with the house phones or used terminals.

Specifically, it is advantageous that the mobile wireless device can be placed in WLAN reaching distance from the router connected to the wireless device uses when selecting a desired telephone number and this use as an external provider for telephone calls and other data transfers in any networks.

It is further advantageous that the mobile device is in any type of network can dial.

Another advantage is that the router is able to communicate via wireless with the mobile device.

Additionally, it is advantageous that the mobile station is able to communicate by WLAN wireless with a router.

It is also advantageous that the software generated in the mobile device installs a complete VoIP server that is configured in the router as an external VoIP provider and is set for predetermined outgoing calls.

It is also advantageous that the router can be thereby configured so that all calls are led out via the configured mobile device or on the basis of certain parameters (eg. as area code, day, date, time, price tables), the router makes the decision for which calls the mobile station is set as the network provider.

It is further advantageous that the mobile device establishes the connection to the selected destination number, whereby the data of the audio signal are transmitted in both directions via the mobile radio device and the router.

Another advantage is seen in the fact that all addressed to the phone number of the mobile phone calls via the mobile device and the router to the house phones connected to the router or Terminals can be passed.

It is also advantageous that the router is capable of providing telephony and Internet connections.

Advantageously it establishes further that the router is capable of multiple network providers to operate in parallel.

An advantage is further seen in that the configuration of the router can be performed automatically using the pre-installed software on the mobile device.

Furthermore, it is advantageous that the mobile device can be placed in wireless WLAN range of the router wherever the best mobile network connection exists.

In addition, it is advantageous that the mobile device can also be made accessible through the IP network for use at remote locations (on the Internet).

In the now following, the invention will be described in detail with reference to drawings. It shows:

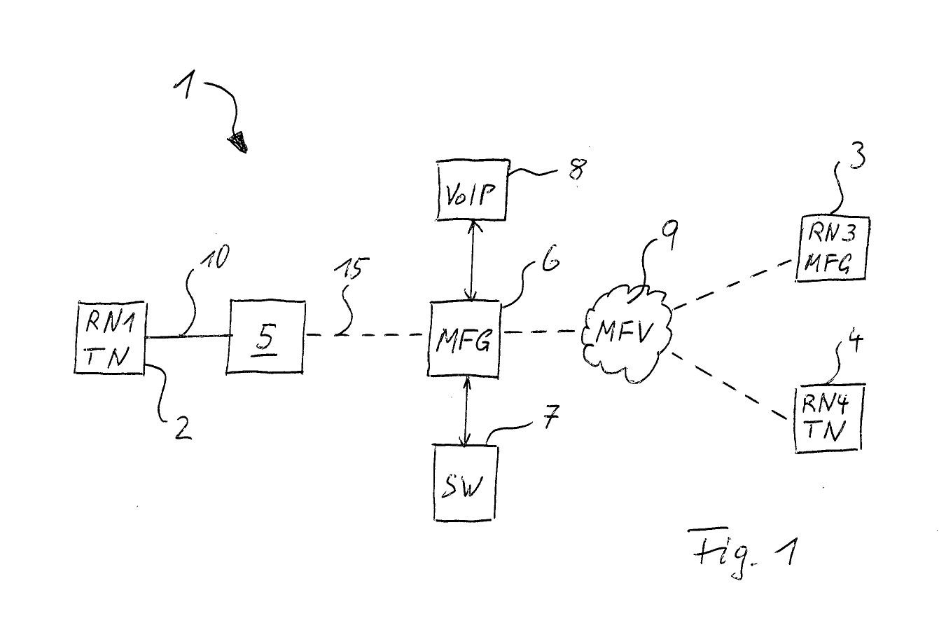

FIG. 1 shows a block diagram of the system (1) between a first participant (2) and any second subscriber (3, 4);

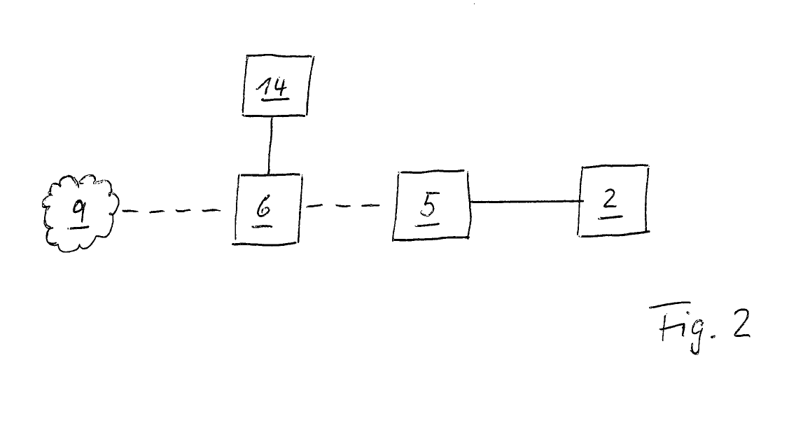

FIG. 2 is a block diagram of a detail of the system (1) in the range of at least one home telephone or, respectively, terminal device (2);

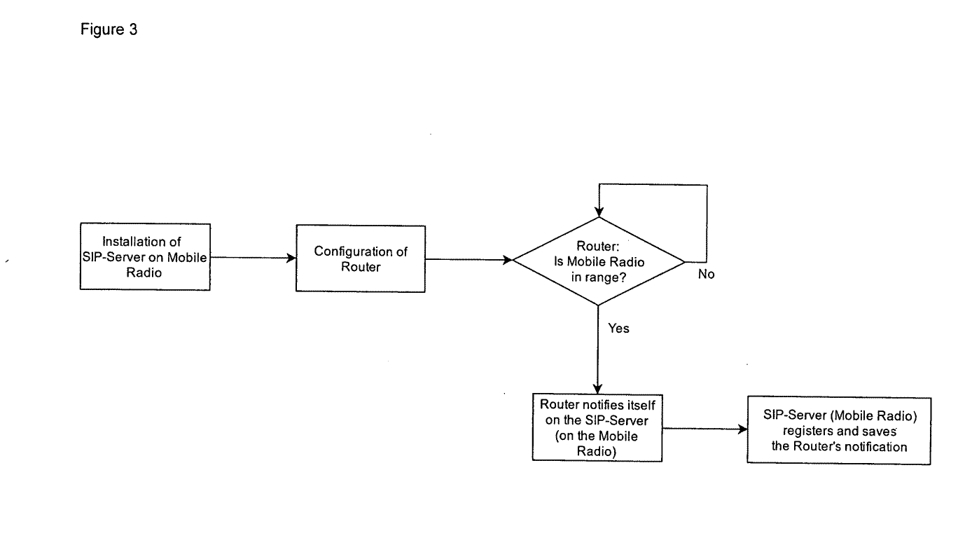

FIG. 3 shows a flow chart of the method according to the invention with a configured router (5) and at least one pre-installed mobile phone (6);

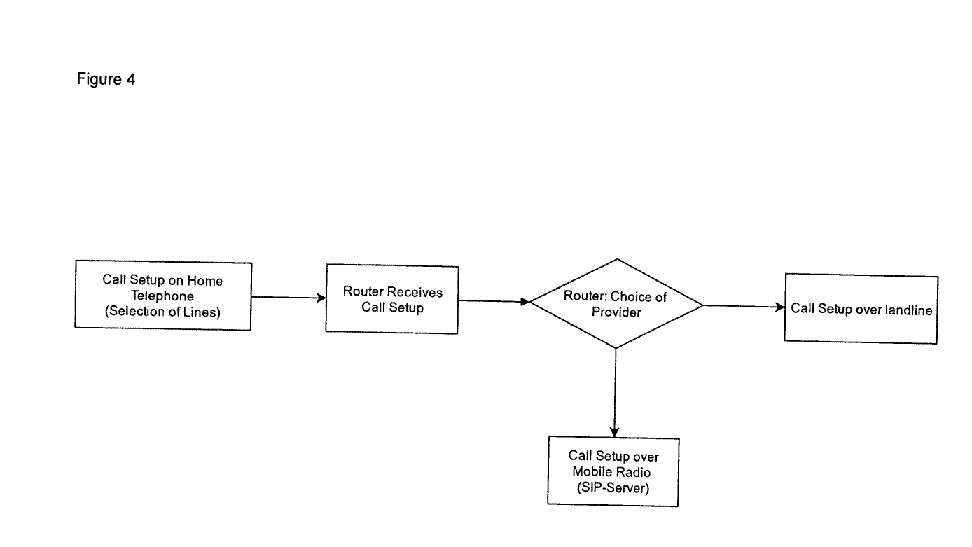

FIG. 4 is a flowchart of a second application case of the method according to the invention with a router configured (5) and at least one pre-installed mobile phone (6);

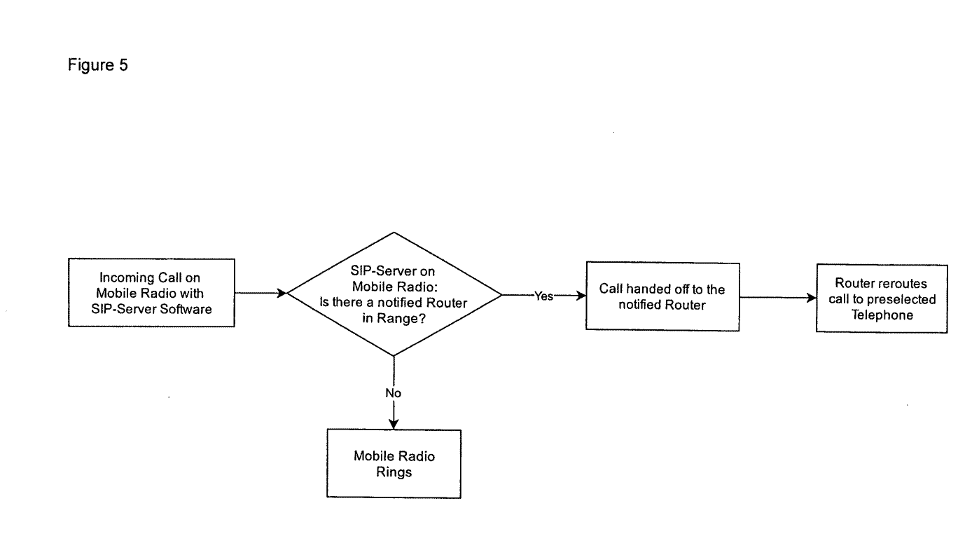

FIG. 5 shows another flow chart of the method according to the invention with at least one pre-installed mobile phone (6);

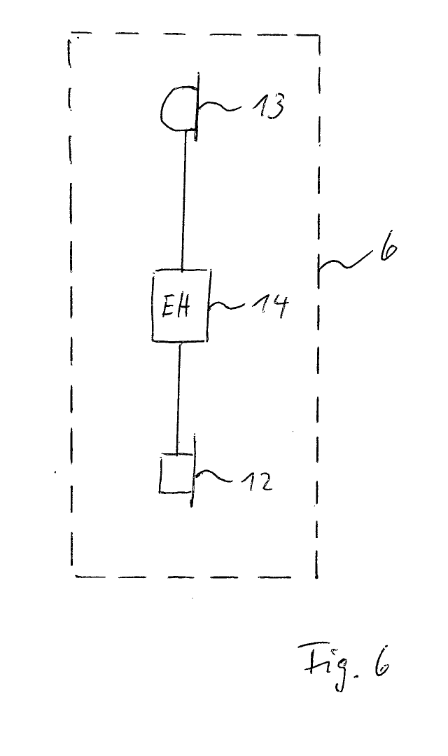

FIG. 6 shows a block diagram of a mobile radio device (6) in which the microphone (12) and the handset or loudspeaker (13) are connected to a switching unit (14).

The FIG. 1 shows a block diagram of the system 1 with a local subscriber (2) and at least one freely selectable telephone subscriber (3, 4), wherein the freely selectable telephone subscriber can be either a mobile (3) or a fixed network subscriber (4). The system 1 is characterized moreover acted upon by the interaction of a configured router (5) and one characterized with a software (7) impacting the mobile radio device (6). The mobile station (6) can be both a smartphone and tablet, or similar device on which the software (7) is installed. The mobile radio device (6) further includes a VoIP platform (8), which in principle allows a VoIP gateway in a mobile network (9), so that between the mobile station (6) and any telephone subscriber (3,4) call data can be transferred into an IP network. The mobile station (6) is in the range of the router (5) positioned so that it ensures data exchange (14) between these two devices is (for example via wireless, cable connection, USB, etc.). The telephone subscriber (2) is connected to the router (5) via a data link (for example via wireless, WLAN, cable connection, USB, etc.) (10).

FIG. 2 shows a schematic block diagram in the immediate area of the router (5) which is connected through the data connection (10) to the telephone subscriber (2), or, respectively, is connected to the terminal of the subscriber. The router (5) and the mobile station (6) exchange data wireless through WLAN or a wired data connection (14). The call data originating from the subscriber (2) are transmitted by radio to the mobile network (9) and directed from there to the various telephone subscribers (3, 4). Since it is generally not possible with mobile terminals to take a direct access to the incoming audio data, the headset output of the mobile radio device (6) is connected with an additional electronic switching unit (11) which shortens the microphone (12) to the output of the handset (13). This function is described in more detail below.

FIG. 3 shows a schematic data-flow diagram of the method according to the invention, wherein the router (5) is already configured according to the requirements of the invention. This procedure describes in abbreviated manner the steps necessary on a mobile phone (6), tablet etc. which furnishes the VoIP server function and the configuration of the terminals to be telephoned to.

For example in a first step, a software is installed on the phone (6), or a tablet etc. (In the form of an “app”). The software on the mobile radio device on which the software was installed, in addition to the previous features, a server for Internet telephony (VoIP, Voice over IP) and thus serves as a VoIP gateway in the VoIP platform (8), via which in combination with a further terminal (VoIP client, for example, router) call data over the mobile network (9) can be handled.

In a second step to configure additional terminals occurs (router with connected telephones, VoIP phone, etc.) so that they log on the device from the first process step. This case is identical to that of the approach here, as if one were at this terminal install a traditional VoIP provider, which also operates the SIP server, but with the difference that the vendor in this case is no telecommunication company is that its SIP Server operates on the Internet, but the provider is in this case the device from the first step on which the SIP server is running.

The manual configuration of the second step can be optional automated as during the installation of the software from the first process step.

By installing the software (7) on the mobile radio station (6), the mobile radio station (6) becomes a private provider of telephony services. Due to the integration of the mobile radio device (6) with the software (7) as “telephony provider” in the domestic telecommunications landscape, the existing home phones (2), while also benefiting from the contractual terms of the mobile phone contract, without changing the terminal or the mobile radio station (6) or, respectively, the need to use the mobile radio station as a terminal.

FIG. 4 schematically shows the data flow diagram of a further use case of the inventive method, wherein the software (7) has been installed on the mobile radio station (6) and the terminal (2) which is to be used is appropriately configured. This use case corresponds to an outgoing telephone call, in which the data is generated by the subscriber (2) and are to be fed to any desired subscriber (3,4) .

In a first step, a desired telephone number is dialed at the terminal (2), or, respectively, connected to a VoIP router (5) selected any phone number and the request is forwarded, through the router to the mobile radio phone, tablet, etc. on which the SIP server is installed.

In a second procedure step, the mobile radio telephone (6) on which the SIP server (7) is installed, receives the request and establishes a connection to the dialed number over the air (9). Then, the terminal from which the request was received, signaled the call setup, then as soon as the called subscriber (3, 4) decreases, and the connection is made to the called party, the successful establishment of the telephone connection to the terminal (2) is signaled and transmits the voice data. Now Sets on one of the participants, this action is signaled accordingly in both directions and the phone connection, or mobile connection is terminated.

The FIG. 5 shows a third use case of incoming call data, wherein the software (7) is already installed and the terminals (2, 5) of the system 1 are configured and connected accordingly. Here go the mobile radio station (6) call data to the mobile radio phone number (for example 0177 1234567).

In a second method step, the software (7) recognizes on the mobile radio station (6) the incoming call and the incoming call signals to the router (5). In a further step the router (5) receives the request and signals the incoming call to the connected telephones (2). As soon as a call request enters the mobile radio station (6) for receiving a call request is accepted by a telephone (2) connected to the router, the voice connection is produced. If one of the participants interrupts the connection, that is signaled accordingly in both directions and the phone connection (or Cellular connection) terminated.

FIG. 6 schematically shows a block diagram of a mobile radio device (6), wherein the microphone (12) and the receiver (13) are interconnected by means of a switching unit (14). In (mobile radio) telephony equipment generally there is simultaneous access to incoming call data (output on the speaker) and outgoing call data (recorded by the microphone) (software and/or hardware technology) blocked. The reproduced through the handset data can usually be lossy only on the speakerphone function of the same device with the microphone and recorded with noise. The switching unit (14) to bypass the function that restriction by short circuit of the microphone and handset. Thus, incoming call data, which are usually represented by the handset can be recorded with virtually no loss over the microphone input of the device. The switching unit (14) used to connect the reproducing listener and recording microphone headset connection or headphones (13) and microphone port (12) of the device.

With the present invention, in particular with the software (7) is a mobile radio device in general converted to a mobile VoIP server, which is everywhere available where a cellular connection exists. It is not necessary to be used at home with a router. The software (7) can also with any VoIP phones and terminals, which via a data interface (for example WLAN, LAN, USB) are connected to the wireless device, are used to make calls via the VoIP platform on the mobile radio device and receive, without the mobile radio station (6) is used as a terminal. With the provided software (7) of the mobile phone contract and any other persons can over an IP data network, for example on the Internet, made consumers. So could for example. International calls are handled by a device connected to the Internet mobile device that is stationary in the selected countries, from Germany.

The call is therefore handled according to the conditions of the destination country.

1. A method for selecting a desired telephone conversation subscriber (3,4) via the telephone connection of a mobile network (9), whereby the caller side (2) has at least one router (5) and at least one mobile radio station (6), is installed on the software (7), in addition to the already existing functions, providing at least a function that generates a VoIP server (8), so that upon selection of the desired telephone number from the terminal (2), produced on the on the mobile radio station (6) VoIP platform (7, 9) to the dialed number made a connection via the mobile network.

2. The method of claim 1, wherein the router (5) for dialing a desired telephone number connects to the router near mobile radio station (6) and uses this as an external provider for telephone calls and other data transfers in any networks.

3. The method of claim 1, wherein t h e router (5) is able to communicate via a data link to the mobile radio station (6).

4. The method of claim 1, wherein the software (7) on the mobile radio station (6) generates a VoIP server, which is in the router (5) configured as a source for external calls.

5. The method of claim 1, wherein the mobile radio station (6) connects to the selected destination number, and the data of the audio signal are led in both directions of the mobile radio station (6) and the router (5).

6. The method of claim 1, wherein a generally known switching unit (11) connects to the listener output of the mobile radio station (6), wherein the known switching unit (11) is connected to the microphone input of the mobile radio station (6).

7. The method of claim 1, wherein the router (5) is configured such that for selected calls, a predetermined mobile radio station (6) is set as the network provider.

8. A method according to one of the preceding claims , wherein the configuration of the router (5) can be made automatically by means of pre-installed software (7) on the mobile station (6).

9. System (1) for diialling a desired telephone conversation subscriber (3,4) over a mobile radio network (9) on a mobile radio carrier, with at least one router (5) on the caller side and at least one mobile radio station (6) on the caller side on which a software (7) is installed, wherein the preinstalled software (7) generates an additional VoIP server function automatically, which makes it possible to use the mobile radio station (6) as a VoIP server, so that when selecting a desired telephone number (3, 4) the speech data are fed over the mobile radio connection (9) to the selected phone number, or, respectively, the telephone subscriber (3,4).

10. The system of claim 11, wherein the router (5) is adapted to provide telephony and Internet connections.

11. The system of claim 11, wherein the router (5) is able, at least to use a VoIP phone provider.

12. System (1) according to claim 11, wherein a unit (11) transmits the speech data from the receiver (13) of the mobile radio device (6) with the microphone of the mobile radio device (6) and vice versa.

13. System (1) according to claim one of the preceding claims, wherein the switching unit (11) Is designed as a pluggable stick.
